(19) United States
(12) Patent Application Publication
(10) Pub. No.: US 2025/0152461 A1
(43) Pub. Date: May 15, 2025

(54) MULTI-ENERGY GENERATOR APPARATUS, METHODS, AND SYSTEMS

(71) Applicants: DATAFEEL INC., WASHINGTON, DC (US); NUtech Ventures, Lincoln, NE (US)

(72) Inventors: Eric Markvicka, Lincoln, NE (US); Patrick McManigal, Lincoln, NE (US); Evan Hailey, Lincoln, NE (US); Matthew Leaper, Omaha, NE (US)

(73) Assignees: DATAFEEL INC., WASHINGTON, DC (US); NUtech Ventures, Lincoln, NE (US)

(21) Appl. No.: 18/945,391

(22) Filed: Nov. 12, 2024

Related U.S. Application Data
(60) Provisional application No. 63/548,111, filed on Nov. 10, 2023.

(51) Int. Cl. A61H 23/02; G06F 3/01

(52) U.S. Cl. CPC A61H 23/0245; G06F 3/016; A61H 2201/0207; A61H 2201/0214

(57) ABSTRACT

Multi-energy generator apparatus, methods, and systems are disclosed. One multi-energy apparatus comprises: a housing with a biocompatible skin interface comprising a first skin contact operable to transmit a first energy in a signal direction toward skin of a user, and a second skin contact that surrounds the first skin contacting portion and is operable to transmit a second energy in the signal direction toward the skin; and a plurality of PCBs that are operatively sealed in the housing, the plurality of PCBs comprising a first generator operable to output the first energy to the first skin contact for transmission to the skin, a second generator that surrounds the first generator and is operable to output the second energy to the second skin contact for transmission to the skin, and a controller operable to activate the first generator and the second generator.

### CROSS-REFERENCE TO RELATED APPLICATIONS

This application claims the benefit of priority to U.S. Provisional Patent Application No. 63/548,111 filed Nov. 10, 2023, the entirety of which is hereby incorporated by reference into this application.

### TECHNICAL FIELD

Aspects of the present disclosure generally relate to multi-energy generator apparatus, methods, and systems. Particular aspects relate to wearable technologies with applications in communication and/or therapy.

### BACKGROUND OF THE INVENTION

Existing communication technologies like augmented reality, mixed reality, and virtual reality are limited to audiovisual stimulus and vibration, making it impossible to communicate certain environmental aspects to the brain, like hot, cold, and combined effects, even though these aspects are commonly represented audiovisually.

Existing pharmaceutical solutions can have unintended consequences that can be reduced or avoided with physics-based alternatives such as “energy prescriptions” delivered to the skin as measured doses of combinations of different energy types, such as thermal and vibrational energies optimized to realize similar outcomes.

### SUMMARY OF THE INVENTION

Aspects of a multi-energy generator apparatus, methods, and systems are disclosed. One aspect disclosed herein is a multi-energy generator apparatus comprising: a housing with a biocompatible skin interface comprising a first skin contact operable to transmit a first haptic energy in a signal direction toward skin of a user, and a second skin contact that surrounds the first skin contacting portion and is operable to transmit a second haptic energy in the signal direction toward the skin; and a plurality of PCBs that are operatively sealed in the housing, the plurality of PCBs comprising a first haptic generator operable to output the first haptic energy to the first skin contact for transmission to the skin, a second haptic generator that surrounds the first haptic generator and is operable to output the second haptic energy to the second skin contact for transmission to the skin, and a haptic controller operable to activate the first haptic generator and the second haptic generator.

The housing may comprise a side structure that mechanically supports the plurality of PCBs. The side structure may comprise an aluminum portion that is thermally coupled to the plurality of PCBs. The aluminum portion may be operable as a heat sink for one or more of the first haptic generator, the second haptic generator, and the haptic controller. The plurality of PCBs may comprise a thermally conductive via extending between the aluminum portion and the one or more of the first haptic generator, the second haptic generator, and the haptic controller.

The housing may comprise a front cover with an opening. The plurality of PCBs may be operatively sealed in the housing by a seal formed between the biocompatible skin interface and the opening. The second skin contact may comprise an annular shape with a central opening. The first skin contact may be receivable in the central opening. The plurality of PCBs may be operatively sealed in the housing by an outer seal formed between the second skin contact and the opening an inner seal formed between the first skin contact and the second skin contact.

The first skin contact may comprise an indenter that is engaged with the first haptic generator and operable to focus the first haptic energy on a smaller area of the skin when the apparatus is pressed against the skin. The indenter may comprise a semi-spherical shape that is engaged with the first haptic generator and made of first biocompatible material operable to transmit the first haptic energy to the smaller area of the skin. The plurality of PCBs may comprise an adapter that attaches the first haptic generator to the plurality of PCBs and presses the indenter toward the smaller area of the skin when the apparatus is pressed against the skin. The adapter may comprise a beam portion that resiliently presses the indenter toward the smaller area of the skin.

The first haptic energy may comprise or consist essentially of a vibratory energy and the first skin contact may comprise a first biocompatible material operable to transfer the vibratory energy to the skin. The first biocompatible material may comprise a heat-resistant silicone. The first biocompatible material may contain an embedded amount of liquid metal that increases a mass the first skin contact and thus its ability to transfer the vibratory energy to the skin.

The second haptic energy may comprise or consist essentially of a thermal energy and the second skin contact may comprise a second biocompatible material operable to transfer the thermal energy to the skin. The second biocompatible material may comprise a thermally conductive silicone. The second biocompatible material may comprise an embedded amount of liquid metal positioned to increase a thermal conductivity of the second skin contact and thus its ability to transfer the thermal energy to the skin.

The apparatus may comprise an insulative element that is contained in the housing and positioned to maintain a position of the plurality of PCBs in the housing and limit flows of electricity and heat between the plurality of PCBs. The insulative element may comprise a dielectric epoxy contained in voids between the first haptic generator and the second haptic generator. The plurality of PCBs may form an integrated circuit stack that is engaged with and operatively sealed in the housing. The apparatus may comprise pins operable to form the integrated circuit stack by mechanically attaching the plurality of PCBs to one another. The pins may comprise a conductive material operable to transmit electricity between the plurality of PCBs. The pins may comprise a thermally conductive portion operable to transmit thermal energy between the plurality of PCBs and an electrically insulative portion operable to limit transmissions of electricity between the plurality of PCBs.

The first haptic energy may comprise or consist essentially of a vibratory energy, and the first haptic generator may be operable to output the vibratory energy responsive to a first electric current directed to the first haptic generator. The first haptic generator may comprise a linear resonate actuator, a piezoelectric actuator, or another type of electromechanical device. The second haptic energy may comprise or consist essentially of a thermal energy, and the second haptic generator may be operable to output the thermal energy responsive to a second electric current directed to the second haptic generator. The second haptic generator may comprise a thermoelectric element operable via the Peltier Effect to output the thermal energy responsive to the second electric current. The thermal energy may comprise a cold energy and a heat energy, and the thermoelectric element may be reversibly operable to output either the cold energy or the heat energy based on a direction of the second electric current.

The thermoelectric element may comprise an interconnecting PCB attachable to the first haptic generator, an interface PCB attachable to the second skin contact, and thermoelectric pellets contained between the interconnecting PCB and the interface PCB. The interconnecting PCB and the interface PCB may define electrically conductive vias extending between the thermoelectric pellets, and the thermoelectric pellets may be operable with the electrically conductive vias to convert the second electric current into the thermal energy. The interconnecting PCB and the interface PCB may comprise annular shapes. The thermoelectric pellets may be arranged between the annular shapes in a radial array. The first haptic generator may be located in a central opening of the annular shapes. The interface PCB may comprise conductive pads operable to transmit the thermal energy into the second skin contact. The conductive pads may be adjacent to, embedded in, or extend through the second skin contact. The first haptic generator may be engaged with an adapter. The adapter may be removably engageable with the interconnecting PCB.

The thermoelectric pellets may comprise two different types of semiconductors that are engaged in pairs. The two different types of semiconductors in each pair may comprise one P-type thermoelectric semiconductor and one P-type thermoelectric semiconductor. The N-type and P-type thermoelectric semiconductors may be made of Bi₂Ti₃. A polarity of each N-type thermoelectric semiconductor may be different from a polarity of each N-type thermoelectric semiconductor. The interconnecting PCB may comprise a first substrate and the interface PCB may comprise a second substrate. The first substrate and the second substrate may be made of different materials with different conductivities. The first substrate may comprise a thermally insulating material and the second substrate may comprise a thermally conductive material. At least the first substrate may comprise ceramic, FR4, or polycarbonate and/or at least the second substrate may comprise aluminum or gallium nitride.

The plurality of PCBs may comprise a base PCB for the haptic controller. The base PCB may comprise a microcontroller, a power controller, a USB driver, a first haptic driver for the first haptic generator, a second haptic driver for the second haptic generator, and/or a sensor. The microcontroller may be operable to send first control signals for routing the first electric current the first haptic generator in a first direction causing outputs of the cold energy, second control signals for routing the second electric current to the second haptic generator in a direction causing outputs of the heat energy, third control signals for routing the second electric current to the second haptic generator in an opposite direction causing outputs of the vibratory energy, and fourth control signals for causing the sensor to generate or output sensory data. The sensor may comprise one or more temperature sensors that are in data communication with the microcontroller and operable with the thermoelectric element to regulate the thermal energy. The one or more temperature sensors may comprise a first sensor on the base PCB, a second sensor engaged between the interconnecting PCB and the interface PCB, and/or a third sensor engaged with a skin-facing side of the interface PCB.

Another aspect described herein is a multi-energy generator method. For example, the method may comprise pressing a multi-energy generator apparatus like those described herein against the skin and causing groups of the thermoelectric pellets to output the thermal energy. The method may comprise activating the groups in sequence to move the thermal around the radial array of the thermoelectric pellets in a circular motion. The method may comprise positioning a plurality of multi-energy generator apparatus like those described herein on the skin and causing groups of the thermoelectric pellets of each thermoelectric element of each apparatus to output a portion of the thermal energy in a coordinated manner causing one of a concentration of the thermal energy between the apparatus and a sweep of the thermal energy across the apparatus.

Another aspect described herein is a multi-energy generator system. For example, the system may comprise a multi-energy generator apparatus like those described herein and a spreader that is removably engageable with the second skin contact and operable to spread the second haptic energy over a larger area of the skin. The spreader may comprise a biocompatible base material, and conductive elements that are embedded in the base material to increase is thermal conductivity. The system may comprise a biocompatible adhesive operable to attach the apparatus to the skin.

Related aspects of a multi-energy generator apparatus, methods, and systems also are disclosed herein, each combination and/or iteration being part of this disclosure.

### BRIEF DESCRIPTION OF THE DRAWINGS

The accompanying drawings, which are incorporated in and constitute part of this disclosure, illustrate exemplary aspects that, together with the written descriptions, serve to explain the principles of this disclosure. Numerous aspects are particularly described, pointed out, and taught in the written descriptions. Some structural and operational aspects may be even better understood by referencing the written portions together with the accompanying drawings, of which:

FIG. 1 depicts an assembled view of an exemplary multi-energy generator;

FIG. 2 depicts a rotated view of the FIG. 1 generator;

FIG. 3 depicts a bottom view of the FIG. 1 generator;

FIG. 4 depicts an exploded view of the FIG. 1 generator;

FIG. 5 depicts an exploded view of operating elements of the FIG. 1 generator;

FIG. 6 another exploded view of the FIG. 1 generator;

FIG. 7 depicts a circuit diagram for the FIG. 1 generator;

FIG. 8 depicts a cross-sectional view of the FIG. 1 generator;

FIG. 9 depicts another cross-sectional view of the FIG. 1 generator;

FIG. 10 depicts a partial activation thermal elements of the FIG. 1 generator;

FIG. 11 depicts an activation pattern of thermal elements of FIG. 1 generator;

FIG. 12 depicts a plurality of FIG. 1 generators arranged in a radial array and an activation pattern associated with the radial array;

FIG. 13 depicts a plurality of FIG. 1 generators arranged in a linear array and an activation pattern associated with the linear array; and

FIG. 14 depicts the FIG. 1 generator engaged with an energy spreader.

Some aspects depicted in the drawings may be explained further by way of citations to their drawing and element numbers. The drawings and any citations thereto are provided for illustration purposes, and to further clarify the description of the present disclosure. They are not intended to limit the present disclosure unless claimed.

### DETAILED DESCRIPTION

Aspects of the present disclosure are not limited to the exemplary structural details and component arrangements described in this description and shown in the accompanying drawings. Many aspects of this disclosure may be applicable to other aspects and/or capable of being practiced or carried out in various variants of use, including the examples described herein. Any example or variation may be claimed.

Throughout the written descriptions, specific details are set forth in order to provide a more thorough understanding to persons of ordinary skill in the art. For convenience and ease of description, some well-known elements may be described conceptually to avoid unnecessarily obscuring the focus of this disclosure. In this regard, the written descriptions and accompanying drawings should be interpreted as illustrative rather than restrictive, enabling rather than limiting.

Exemplary aspects of this disclosure reference multi-energy haptic generator apparatus, methods, and systems. Some aspects are described with reference to particular structures (e.g., a housing) made with one or more materials (e.g., metallic and/or polymeric) using a particular manufacturing method (e.g., cast forming, pressure injection molding, or 3D printing) into a particular shape (e.g., cylindrical) surrounding a particular type of electronics (e.g., single-energy haptic generators) wearable on a particular location (e.g., on or adjacent the skin) of a particular user (e.g., a living being, such as a mammal or reptile). Unless claimed, these exemplary aspects are provided for convenience and not intended to limit this disclosure.

Several reference axes are described, including: a longitudinal axis X-X, a lateral axis Y-Y, and a vertical axis Z-Z. Various aspects are described relative to these axes. Each axis X-X, Y-Y, and Z-Z may define relative arrangements. For example, each longitudinal axis X-X may be non-parallel with at least one lateral axis Y-Y in some perspectives, meaning that axis Y-Y may extend across and/or intersect axis X-X. Terms such as “long” and “elongated” may describe any aspect having a length along one of axes X-X, Y-Y, or Z-Z that is longer in relation to a width along a non-parallel one of axes X-X, Y-Y, or Z-Z. Additional axes, movements, and forces also may be described with reference to axes X-X, Y-Y, and/or Z-Z. Anatomical terms such as “anterior” and “posterior,” “medial” and “lateral,” and “proximal” and “distal” may be used to describe some structures in relation to an exemplary position and/or orientation. These relative terms are provided for convenience and ease of description, and do not limit this disclosure unless claimed.

As used herein, inclusive terms such as “comprises,” “comprising,” “includes,” “including,” and variations thereof, are intended to cover a non-exclusive inclusion, such that any apparatus, methods, system, or element thereof described herein as comprising an exemplary list of elements does not include only those elements, but may include other elements not expressly listed and/or inherent thereto. Unless stated otherwise, the term “exemplary” is used in the sense of “example,” rather than “ideal,” and does not limit this disclosure unless claimed. Various terms of approximation may be used in this disclosure, including “approximately” and “generally.” Unless stated otherwise, approximately means within 10% of a stated number or outcome and generally means “within most cases” or greater than 50% chance.

Terms such as “engageable with,” “engaged with,” and “engaging” are used in this disclosure to describe connections between two or more elements. Some connections may be non-removably and/or non-rotatably engaged, such as when two elements are formed together and cannot be rotated and/or separated without damage. Other connections may be removably and/or rotatably engaged, such as when two elements are coupled together by engagement elements (e.g., bolts, pins, rods, screws, etc.) to form structures (e.g., joints, hinges, etc.) allowing the elements to be rotated relative to one another and/or separated from another without damage. The term “pin” is used as an exemplary means for placing one element such (e.g., a first circuit board) in slidable engagement with another (e.g., a second circuit board) and should be broadly interpreted to include any structures suitable for obtaining slidable engagements. Accordingly, unless stated otherwise, the term engageable, pin, and their equivalents should be broadly interpreted to comprise any obvious variations thereof.

Aspects of exemplary computing technologies are described herein with reference to terms like “controller” or “microcontroller”. Functional terms such as “processing,” “computing,” “calculating,” “determining,” “displaying,” and the like, may refer to actions and processes performable by any controller described herein, which may comprise any type of software and/or hardware. The software of the controller may comprise program objects (e.g., lines of codes) that are executable locally and/or with a remote computing technology (e.g., a cloud-based system) to perform various functions. Each program object may comprise a sequence of operations leading to a desired result, such as an algorithm. The operations may require or involve physical manipulations of physical quantities, such as electrical or magnetic signals capable of being stored, transferred, combined, compared, and otherwise manipulated. The signals may be described conceptually as bits, characters, elements, numbers, symbols, terms, values, or the like.

The hardware of the controller may comprise any memory technologies for storing the program objects and any data associated therewith. For example, the program objects may be stored in any machine (e.g., a computer) readable storage medium in communication with the processing unit, including any mechanism for storing or transmitting data and information in a form readable by a machine (e.g., a computer). Exemplary storage mediums may comprise read only memory (“ROM”); random access memory (“RAM”); erasable programmable ROMs (“EPROMs”); electrically erasable programmable ROMs (“EEPROMs”); magnetic or optical cards or disks; flash memory devices; and/or any electrical, optical, acoustical, or other form of propagated signals, such as carrier waves, infrared signals, digital signals, and the like.

In keeping with above, any controller described herein may comprise and/or be operable with a smartphone or similar device, such as an iPhone or other iOS device, an Android phone or other Android device, or any comparable and/or compatible devices operable to perform any functions described herein with reference to any controller.

Some aspects of the present disclosure are described with reference to methods with steps that may be performable with the controller. To help orient the reader, some methods may be described with reference to a conceptual drawing, such as a flowchart with boxes interconnected by arrows. Each box may represent a particular step or technology. The boxes may be combined, interconnected, and/or interchanged to provide options for additional modifications according to this disclosure. The arrows may define an exemplary sequence of operation for the steps, the order of which may be important. For example, a particular order of the steps may describe a sequence of operation that is performable by the controller to realize specific processing benefits, such as improving a computational performance and/or an operational efficiency.

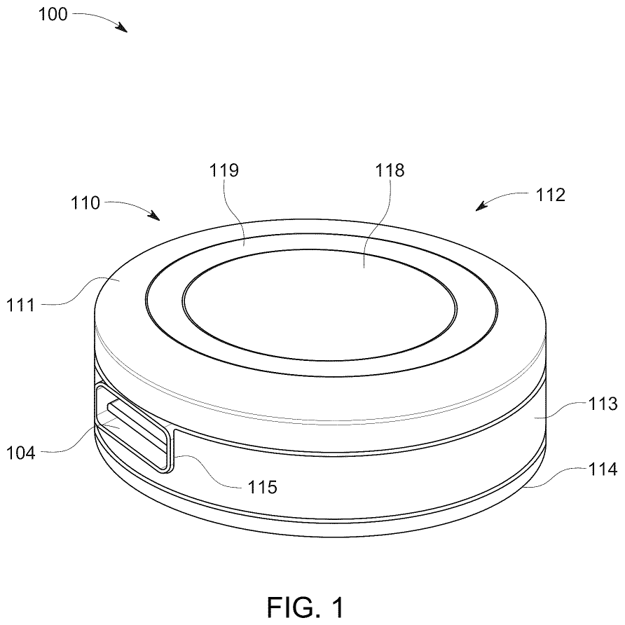

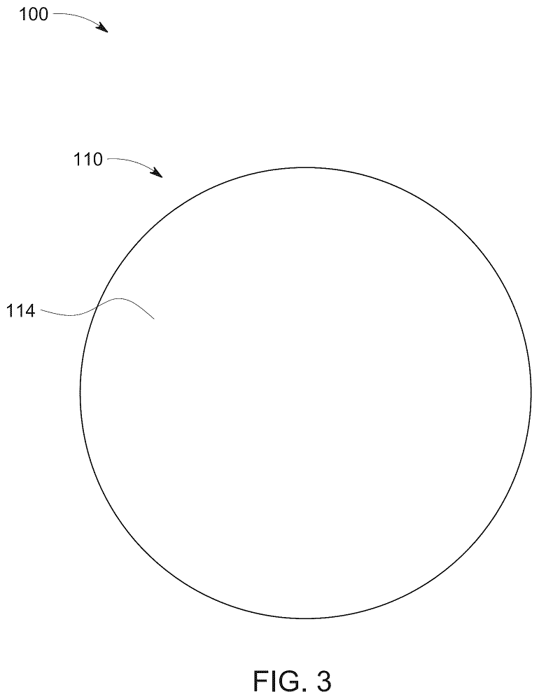

General aspects of this disclosure are now described with reference to an exemplary multi-energy haptic generator 100 shown in FIGS. 1-14 as being an operable part of an apparatus, method, or system configured to provide unique forms of haptic stimuli to skin 2 of a user 1 by outputting combinations of different haptic energies toward skin 2. Without departing from this disclosure, multi-energy haptic generator 100 may alternatively be described as a multi-energy generator 100 or a multi-modal actuator 100.

Aspects of multi-energy haptic generator 100 may output different combinations of haptic sensations responsive to a data stream (e.g., weather from weather.com) and/or a sensor (e.g., a sky-facing camera). The different combination of energies output from generator 100 may interact with different nerves and/or tissues of user 1 for communication applications, such as to alert, notify, and stimulate user 1 responsive to the data source, allowing them to react or receive treatment without looking at a screen; or for therapeutic applications, such as to affect the parasympathetic nervous system of user 1 for mental health treatments or other physiological tissues of user 1 for physical health treatments. To promote placement against skin 2 for extended periods of time, multi-energy generator 100 may be a compact and versatile device that is about the size of a checker piece and operable for extended periods of time (e.g., days).

Generally speaking, multi-energy haptic generator 100 may be described as having a housing, a plurality of single-energy haptic generators, and a haptic controller, in which: (i) the single-energy haptic generators and haptic controller may form an integrated stack of printed circuit boards or PCBs sealed in the housing, similar to a three-dimensional integrated circuit or 3D IC; (ii) each single-energy haptic generators may comprise different haptic energy generating elements engaged with and between the PCBs; and (iii) the haptic controller may be data reactive, meaning that data and/or power transmitted thereto may responsively cause one or more of the plurality of single-energy haptic generators to output their haptic energy at different times.

Particular aspects of multi-energy haptic generator 100 are now described with reference to aspects an exemplary housing (e.g., 110), followed descriptions of aspects of an exemplary single-energy haptic generators (e.g., 131, 133) and aspects of an exemplary haptic controller (e.g., 140). As shown in FIGS. 1-4, housing 110 may comprise a front cover 111, a skin interface 112, a side structure 113, and a back cover 114.

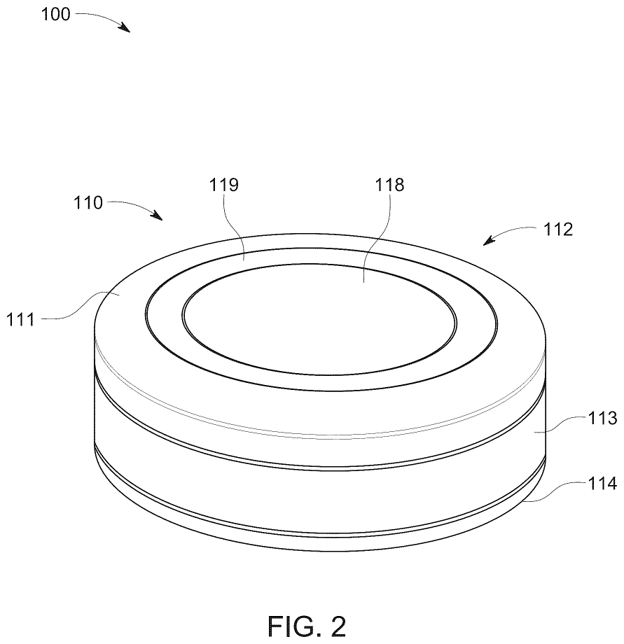

Housing 110 may have a generally cylindrical shape that helps to evenly distribute internal stresses and control deformations when pressed against skin 2 of user 1. As shown in FIGS. 1-4 and 6, aspects of housing 110, such as its interior lining, material composition, and/or thickness, may be optimized to promote flows of haptic energies in directions toward skin 2 (e.g., upwards in FIGS. 1 and 2) and limit flows of haptic energies in directions transverse with the skin (e.g., from left and right in FIGS. 1 and 2), helping to increase the amount of energies deliverable to skin 2.

As shown in FIGS. 1-4 and 6, front cover 111 and back cover 114 may be formed or 3D printed from a polymeric material (e.g., ABS, PLA, PETG) and assembled with side structure 113 to further define the generally cylindrical shape. Side structure 113 may be formed from a metallic material (e.g., aluminum) and positioned to serve as a heat sink for multi-energy haptic generator 100. To further limit flows of the haptic energies in transverse directions, interior surfaces of side structure 113 and/or back cover 114 may comprise thermally reactive materials that absorb and/or direct thermal energies, such as when housing 110 is at least partially filled with an insulative material, like an epoxy.

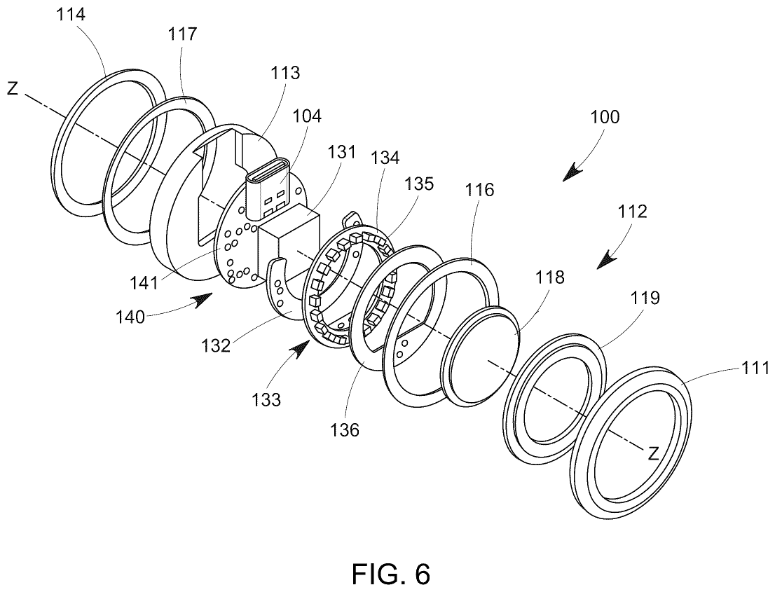

As shown in FIG. 6, front cover 111 may comprise an annular shape defining an interior opening for receipt of skin interface 112 and an outward-facing mating surface shaped for sealable engagement with a skin-facing mating surface of side structure 113. Side structure 113 may comprise an aluminum cylinder with interior surfaces for supporting PCBs, a skin-facing mating surface shaped for sealable engagement with an outward-facing mating surface of front cover 111, and outward-facing mating surface shaped for sealable engagement with a skin-facing mating surface of back cover 114. Back cover 114 may comprise a skin-facing mating surface for sealable engagement with the outward-facing mating surface of side structure 113.

Front cover 111, skin interface 112, side structure 113, and back cover 114 may be engaged to seal the interior of housing 110 from exterior sources of moisture. By way of example, any combinations of adhesives (e.g., a biocompatible epoxy), engagement elements (e.g., threads), and/or insulating seals (e.g., O-rings) may be utilized to form sealed connections between the respective mating surfaces of front cover 111, side structure 113, and back cover 114. As shown in FIG. 6, a first insulating seal 116 may be located between front cover 111 and side structure 113 and a second insulating seal 117 may be located between side structure 113 and back cover 114.

Skin interface 112 may transmit different types of haptic energy to skin 2 while preventing entry of moisture into housing 110. As shown in FIGS. 1, 2, and 6, skin interface 112 may comprise different skin contacting materials for transmitting different types of haptic energy, such as a first skin contact 118 optimized for transmitting a first energy type (e.g., vibratory energies) and a second skin contact 119 optimized for transmitting a second energy type (e.g., thermal energies, hot and cold). As shown in FIGS. 1, 2, and 6, first skin contact 118 and second skin contact 119 may be contained in the interior opening of front cover 111 in a nested configuration. By way of example, first skin contact 118 may be centrally located, second skin contact 119 may surround first skin contact 118, and/or surfaces of second skin contact 119 may engage surfaces of front wall 111, first insulating seal 116, and first skin contact 118 to form additional sealing elements for housing 110.

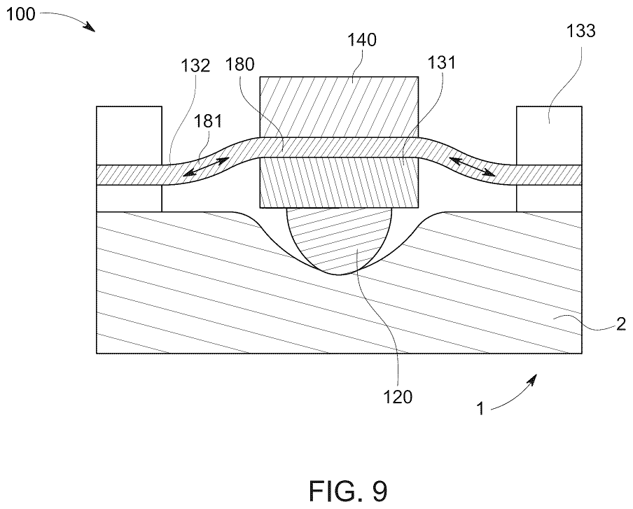

First skin contact 118 may comprise a biocompatible material that is moisture resistant and able to conduct the first energy type to skin 2. Aspects of first skin contact 118 may be optimized to intensify outputs of the first energy type directed towards skin 2. As shown in FIG. 9, the first energy type may comprise a vibratory energy and first skin contact 118 may comprise an indenter 120 that may be pressed deeper into skin 2 when generator 100 is worn to focus the vibratory energy on a smaller area of skin 2 that is resiliently engaged with indenter 120.

Second skin contact 119 may comprise a biocompatible material that is moisture resistant and able to conduct the second energy type to skin 2. Aspects of second skin contact 119 may be optimized to intensify outputs of the second energy type directed towards skin 2. As shown in FIG. 9, the second energy type may comprise a thermal energy (including cold outputs and hot outputs) and second skin contact 119 may be formed from a thermally conductive silicone like those sold by Nolato under the Compatherm® brand.

By way of example, one or both of first skin contact 118 and second skin contact 119 may be formed from a lightweight liquid metal embedded elastomer composition like those described in U.S. Provisional Patent No. 63/153,480, filed Feb. 25, 2021, the entirety of which is hereby incorporated by references into this disclosure. For skin contact 118, the amount of embedded metal in the elastomer may be utilized to amplify the vibratory energy by increasing is mass and/or the mass of indenter 120; and for skin contact 119, the amount of embedded metal in the elastomer may increase its thermal conductivity.

Interior surfaces of side structure 113 may mechanically support one or more PCBs inside of housing 110. As shown in FIGS. 1, 2, 4, and 6, side structure 113 may comprise a cylindrical aluminum shape that mechanically supports and is thermally coupled to the PCBs. Exterior surfaces of side structure 113 may provide multi-energy haptic generator 100 with its cylindrical shape (e.g., FIGS. 1-3) and define a lower portion of opening 115. Because it formed from aluminum and comprises exterior surfaces exposed to the air surrounding multi-energy haptic generator 100, side structure 113 may thus serve as a heat sink for the PCBs, making it easier for generator 100 to discharge excess heat generated therewith and/or by user 1.

Back cover 114 may be removably engaged with outward-facing surfaces of side structure 113. For example, as shown in FIG. 6 and described herein, mating surfaces of front cover 111, skin interface 112, side structure 113, and back cover 114 may be interlocked and fit together to define the sealed interior cavity of housing 110 and prevent the plurality of PCBs contained therein from exposure to moisture in the form of perspiration generated by user 1 when wearing multi-energy haptic generator 100 and/or from exposure to other external sources.

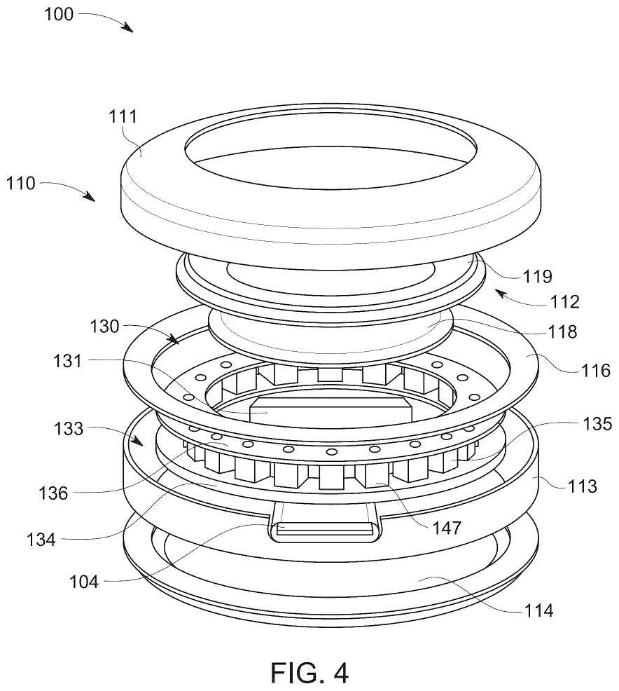

As shown in FIGS. 4-8, for multi-energy haptic generator 100, the plurality of single-energy generators may be part of a first circuit assembly 130, the haptic controller may be part of a second circuit assembly 140, and pins 160 may be used to stack circuit assemblies 130, 140 together to form a 3D IC that is operatively sealed in housing 110. First circuit assembly 130 may comprise a plurality of printed circuit boards (PCBs) positioned to mechanically support and electrically connect the plurality of single-energy haptic generators to one another and the haptic controller inside of housing 110. As shown in FIGS. 4 and/or 6, first circuit assembly 130 may comprise a first single-energy haptic generator 131, an adapter 132, and a second single-energy haptic generator 133.

First single-energy haptic generator 131 may be operable to output a first type of energy consisting essentially of a vibratory energy. As shown in FIGS. 4 and/or 6, first haptic generator 131 may comprise a linear resonate actuator (or “LRA”) or a piezoelectric actuator operable to output the vibratory energy. By way of example, haptic generator 131 may comprise a linear resonate actuator like those sold by Precision Microdrives™ in their Precision Haptic™ range of motors described at https://www.precisionmicrodrives.com/linear-resonant-actuators-Iras (accessed Oct. 14, 2023), the entirety of which is hereby incorporated by reference into this disclosure; and/or a piezoelectric actuator like those sold by TDK in their PiezoHapt™ line of actuators described at https://product.tdk.com/en/products/selectionguide/piezohapt.html (accessed Oct. 17, 2023), the entirety of which also is hereby incorporated by reference into this disclosure.

The vibratory energy from first single-energy haptic generator 131 may be directed to skin 2 by aspects of first skin contact 118 of skin interface 112. As shown in FIG. 9, first skin contact 118 may comprise indenter 120 and be adhered to a skin facing side of first haptic generator 131, such as a skin-facing side of an LRA. In this configuration, multi-energy haptic generator 100 may be pressed against skin 2 by user 1 with a force that causes indenter 120 to be pressed into skin 2 and thus well-positioned to focus the vibratory energy from single-energy haptic generator 131 onto a smaller area of skin 2, maximizing its perceptivity to user 1's brain.

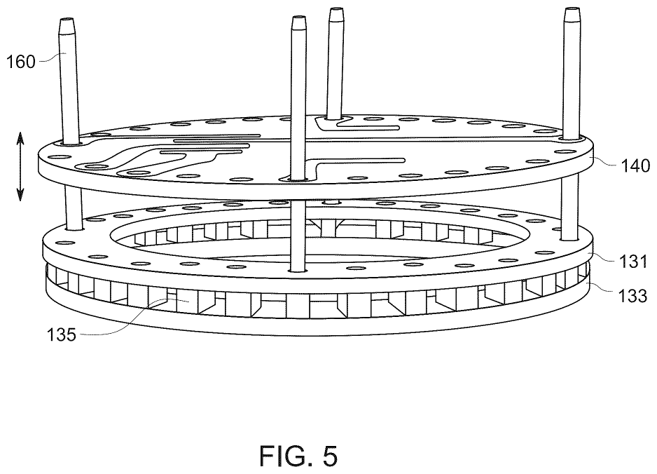

Adapter 132 may comprise one or more PCBs operable to removably engage first single-energy haptic generator 131 to second single-energy haptic generator 133 and second circuit assembly 140 in a stacked configuration that allows electric currents to flow therebetween, similar to a 3D IC. As shown in FIGS. 5 and/or 6, adapter 132 may comprise an adapter PCB of the plurality of PCBs, first single-energy haptic generator 131 may be engaged with an outward-facing side of the adapter PCB, and a skin-facing side of the adapter PCB may be coupled to second circuit assembly 140 and second single-energy haptic generator 133 via pins 160. As shown in FIG. 9, indenter 120 may be fixedly engaged to first haptic generator 131 (e.g., with an adhesive), allowing the first haptic energy (e.g., the vibratory energy) to be more efficiently transferred to skin 2 via skin contact 118 when multi-energy haptic generator 100 is pressed against skin 2 by user 1. In keeping with above, indenter 120 may be made from soft or stiff materials to vary the perceived vibrations, and its topology may be modified to direct the first haptic energy (e.g., the vibratory energy) to specific spots on skin 2.

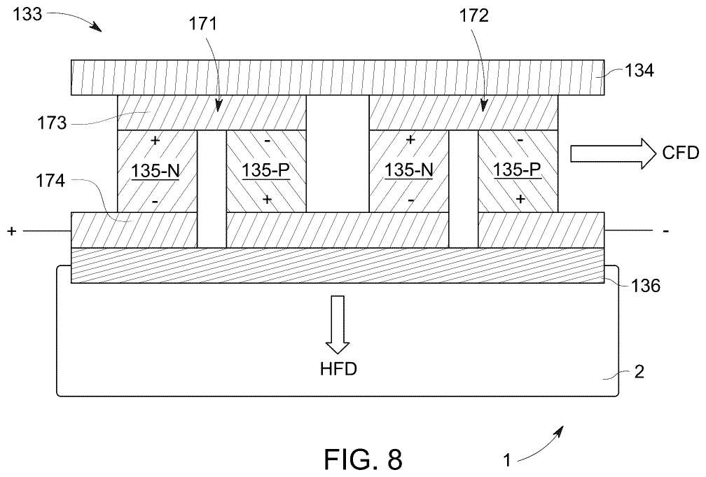

Second single-energy haptic generator 133 may be operable independently of first single-energy haptic generator 131 to output a second type of energy consisting essentially of a thermal energy. As shown in FIGS. 4-7, second single-energy haptic generator 133 may comprise two PCBs and a plurality of thermoelectric pellets 135 located therebetween. As shown in FIG. 8, thermoelectric pellets 135 may be operable with electrically conductive vias formed in and between the two PCBs to convert an electric current flowing in a current flow direction or CFD into different outputs of the thermal energy flowing in a heat flux direction or HFD toward skin 2. The thermal energy may include cold outputs and hot outputs depending on the CFD. By way of example, the cold output may be realized as skin-facing temperature of minus 10-25° or greater from a normal temperature of skin 2 and the heat output may be realized as a skin-facing temperature of plus 10-25° or greater from the normal temperature.

As shown in FIGS. 4 and 6, second single-energy haptic generator 133 may comprise an interconnecting PCB 134, thermoelectric pellets 135, and an interface PCB 136. Each thermoelectric pellet 135 of the plurality may be located between interconnecting PCB 134 and interface PCB 136 and operable to a Peltier cooler. During operation of second haptic generator 133, each pellet 135 may thus have a “hot side” and a “cold side” depending upon a CFD of the electric current flowing therethrough from PCB 134 to PCB 136 or vice versa. Because they are Peltier coolers, one will appreciate that when the CFD of the electric current is reversed, the respective hot and cold sides of each pellet 135 will be switched. As shown in FIG. 8, the CFD may extend from left to right on the page so that the HFD is oriented toward skin 2, causing interface PCB 136 to receive heat outputs from the skin-facing hot sides of pellets 135 and interconnecting PCB 134 to receive cold outputs from the outward-facing cold sides of pellets 135. In contrast to FIG. 8, the CFD may be reversed, extending from right to left on the page so that the HFD is oriented away from skin 2, inversely causing interconnecting PCB 134 to receive heat outputs from the outward-facing hot sides of pellets 135 and interface PCB 136 to receive cold outputs from the skin-facing cold sides of pellets 135.

As shown in FIG. 8, thermoelectric pellets 135 may comprise two different types of semiconductors that are engaged together in pairs and independently operable to output different portions of the thermal energy toward skin 2. Two exemplary pairs 171 and 172 are shown in FIG. 8, each including: (i) one N-type thermoelectric semiconductor made of Bi₂Ti₃ (bismuth telluride) and labelled as 135-N; and (ii) one P-type thermoelectric semiconductor made of Bi₂Ti₃ and labelled as 135-P. As shown in FIG. 8, interior surfaces of interconnecting PCB 134 may comprise electrically conductive pads 173 for outward-facing surfaces of each pellet 135 in each pair 171, 172; and interior surfaces of interface PCB 136 may comprise electrically conductive pads 174 for skin-facing surfaces of one pellet 135 from each pair 171, 172, creating electrically conductive vias extending through and between PCBs 134, 136.

As shown in FIG. 6, PCBs 134, 136 may annular shapes centered on an axis Z-Z. As shown in FIG. 8, pads 173, 174 may be located on opposing interior surfaces of PCBs 134, 136 along axis Z-Z. As shown in FIG. 6, pellets 135 may have quadrilateral shapes (e.g., cubes or cuboids) that are conductively engaged with pads 173, 174 in a radial array about axis Z-Z. The radial array of pellets 135 may desirably help user 1's brain to perceive the thermal energies as having a circular output when all of pellets 135 are activated. As shown in FIG. 8, each pellet 135 may have approximately the same width and be spaced apart from the next pellet 135 by a distance approximately equal to 1-3× their widths around the radial array. In this configuration, user 1's brain may perceive the thermal energy as being fully or partially circular even if fewer pellets 135 are used because of passive tactile spatiotemporal illusions such as the cutaneous rabbit illusion, in which a sequence of haptic stimulus at two separated skin locations (e.g., at the skin-facing surfaces of two active pellets 135 spaced apart from one another around the radial array by a distance of 1-3× their widths) may result in the perception that intervening skin regions were also stimulated (i.e., the spaces between the pellets).

As shown in FIG. 8, pairs 171, 172 of pellets 135 may be arranged in the radial array in an alternating fashion so that the electric current may be circulated around the radial array in a first CFD to cause the cold outputs and a second CFD to cause the heat outputs. As shown in FIG. 8, thermoelectric semiconductors 135-N and 135-P may be alternated with opposing polarities so that the electric current will flow through PCBs 134, 136 and pellets 135 in either the first or second CFD. Different conductive vias may be used to move the electric current around the radial array. As shown in FIG. 8, one conductive via may be established when: (i) the skin-facing surface of thermoelectric semiconductors 135-N from pair 171 an adjacent semiconductor 135-P (off page at left) are engaged with interface PCB 136 with via one of pads 174; (ii) the outward-facing surfaces of semiconductors 135-N, 136-P from pair 171 are engaged with interconnecting PCB 134 via one of pads 173; (iii) the skin-facing surfaces of semiconductor 135-P from pair 171 and semiconductor 135-N from pair 172 are engaged with interface PCB 136 via another one of pads 174; (iv) the outward-facing surface of semiconductors 135-N, 135-P are engaged with interconnecting PCB 134 via another one of pads 173; (v) the skin-facing surface of semiconductor 135P from pair 172 and an adjacent semiconductor 135-N(off page at right) are engaged with interface PCB 136 with via another one of pads 174; and (vi) so forth around the radial array of pellets 135, leaving thermal breaks between each semiconductor 135-N, 135-P and each pad 173, 174 around the radial array.

As shown in FIGS. 4-8, thermoelectric pellets 135 may be sandwiched between interconnecting PCB 134 and interface PCB 136, each of which may comprise a substrate with electrically conductive vias operable to transfer heat and electricity between PCBs 134, 136. Any type of substrates may be used for PCBs 134, 136, such as aluminum, ceramic, FR4, gallium nitride (GaN), polycarbonate, and the like. In PCBs 134 and/or 136 with thermally insulating substrates (e.g., ceramic, polycarbonate), electrically conductive vias may be utilized to transfer heat from thermoelectric pellets 135 into to a heat sink (e.g., side structure 113) or skin 2. In PCBs 134 and/or 136 with thermally conductive substrates (e.g., aluminum, GaN), electrically conductive vias may distribute heating and cooling more uniformly towards the human body, offering advantages in waste heat dissipation. PCBs 134, 136 may have similar or different electrically conductive vias and substrates depending on the application. As shown in FIG. 6, PCB 134 may comprise a ceramic substrate with electrically conductive vias extending toward side structure 113, helping to manage internal temperatures; and PCB 136 may comprise an aluminum or GaN substrate with electrically conductive vias extending between different pellets 136, increasing the amount of thermal energy transmitted to first skin contact 119.

As shown in FIG. 6, side structure 113 and/or back cover 114 may formed from aluminum and positioned to receive excess heat output from the electrically conductive pathways or the thermally conductive substrates. Because of its suitability for high-temperature applications, the substrate of interconnecting PCB 134 and/or interface PCB 136 also may comprise GaN and be thermally coupled to side structure 113 and/or back cover 114, allowing heat to be efficiently transferred through PCBs 134 and/or 136 into structure 113 and/or cover 114. Additional features like heat sinks, fins, or pathways can be incorporated into structure 113, cover 114, and/or the substrate of the PCBs 134, 136 to enhance convective cooling effects.

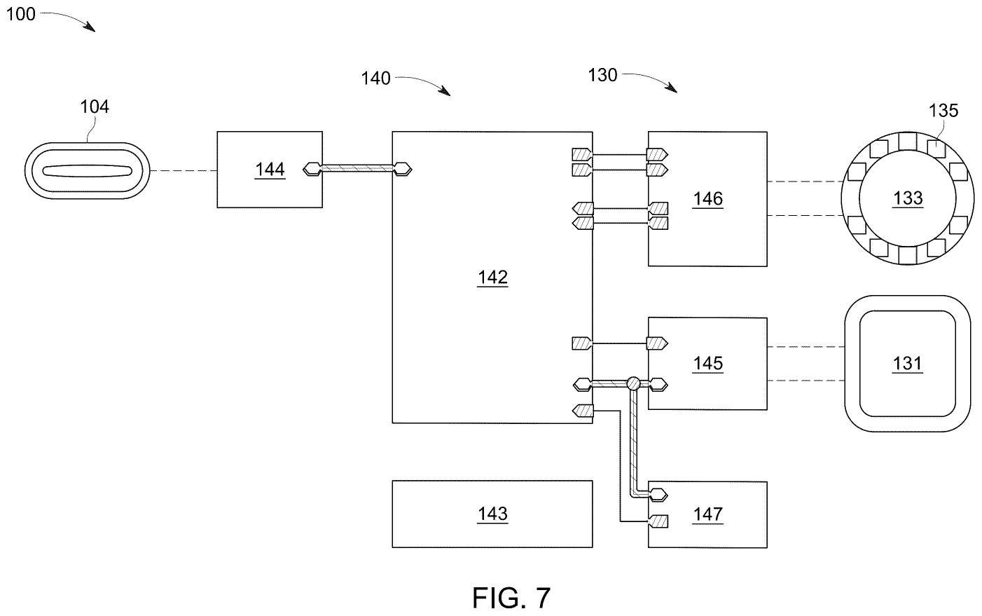

As shown in FIG. 7, PCBs 134, 136 may comprise electrically conductive vias running between different groupings of pads 173, 174, allowing different electric currents to be quickly and efficiently transmitted between different pairs 171, 172 in different directions. Because of these vias, adapter PCB 131, interconnecting PCB 132 and interface PCB 134 may thus be configured to direct different electric currents into and through different groups of thermoelectric pellets 135 in different CFDs at different times. For example, the different conductive vias may be formed into PCBs 134, 136 to operate different groups of pellets 135 independently of other groups of pellets 135, allowing for faster cycling times between cold and hot, localized outputs and patterns of thermal energies, and different thermal effects. Any number of electrically conductive vias may extend through PCBs 134, 136 in two and/or three dimensions, making it possible to control each pellet 135 individually with different control schemes. In these examples, the use of GaN as the substrate may allow PCBs 134, 136 to operate with lower power losses even when pellets 135 are operated to for extended periods of time.

Maximal thermal effects may be realized by activating all thermoelectric pellets 135 at once, allowing for outputs of maximum cold or maximum hot depending on the CFD. At some locations on the body, the mechanoreceptors of skin 2 may be dense enough to communicate similarly with user 1's brain using smaller groups of pellets 135, making it unnecessary to operate all pellets 135 at once. In complement, because it takes longer for each pellet 135 to cycle from maximum cold to maximum heat than it might when starting from room temperature, operating smaller groups of pellets 135 using different electrically conductive vias extending through PCBs 134, 136 may make it easier and faster for thermoelectric pellets 135 to rapidly cycle between cold and hot outputs. For example, including additional conductive via may allowing for activation of a first group of pellets 135 (e.g., a cold output group) responsive to a second control signal (e.g., for cold outputs) while leaving a second group (e.g., a heat output group) idle at a baseline temperature (e.g., room temperature or above) until receipt of a third control signal (e.g., for heat outputs) that activates the second group and idles the first group, allowing the first group to return baseline.

Second circuit assembly 140 may define the haptic controller by locating components for driving first haptic generator 131 and second haptic generator 133 one or more PCBs of the plurality of PCBs, including any combination of processor(s), memory element(s), and transceiver(s) operable to store and execute firmware for operating multi-energy haptic generator 100. As shown in FIG. 7, second circuit assembly 140 may comprise a base PCB 141, a microcontroller 142, a power controller 143, a USB driver 144, a first haptic driver 145, a second haptic driver 146, one or more sensors 147, and a port 148.

Base PCB 141 may comprise another substrate. Because of its suitability for high-temperature applications, the substrate of PCB 141 also may comprise GaN. As shown in FIG. 6, base PCB 141 may be thermally coupled to side structure 113 and comprise holes for removable engagement with front cover 111 and/or back cover 114 via screws and/or pins 160. As before, other types of substrates may be used for base PCB 141, such as aluminum, ceramic, FR4, GaN, polycarbonate, and the like.

Microcontroller 142, power controller 143, USB driver 144, first haptic driver 145, second haptic driver 146, sensor 147, and port 148 may be selected based on their compatibility with first haptic generator 131 and second haptic generator 133.

As shown in FIG. 7, microcontroller 142 may be responsible for generating and/or sending different control signals to first haptic generator 131 and second haptic generator 133. Exemplary control signals for microcontroller 142 may comprise (i) a first control signal for causing the vibratory output by directing a first electric current to first generator 131; (ii) the aforementioned second control signal for causing the cold output by directing a second electric current to a cold group of pellets 135; (ii) the aforementioned third control signal for causing the hot output by directing a third electric current to a hot group of pellets 135; and/or (iv) a fourth control signal for causing sensor 147 to generate and/or output sensory data. For example, microcontroller 142 may be described as an integrated circuit or embedded microcontroller, such as an ARM® Cortex®-M4 PSoC® 6 Microcontroller IC 32-Bit Single-Core 150 MHz 512 KB (512 K×8) FLASH 124-VFBGA (9×9) like those sold by Infineon Technologies with reference to Cypress CY8C6136BZ1-F14 at https://www.digikey.com/en/products/detail/cypress-semiconductor-corp/CY8C6136BZI-F14/9829901 (accessed Oct. 16, 2023), the entirety of which is hereby incorporated by reference into this disclosure.

As shown in FIG. 7, microcontroller 142 may comprise a data transceiver operable to receive data and/or commands via USB, Bluetooth Low Energy, or WiFi for causing first haptic generator 131 and/or second haptic generator 133 to output different combinations of energy and/or follow specific waveforms. Continuing with previous examples, microcontroller 142 may use the data transceiver and a local processor to receive and/or generate the above-described first, second, third, and/or fourth control signals responsive to data from sensor 147 and/or any other source of data.

First haptic driver 145 may be operable to generate the above-described first control signals for causing outputs of vibratory energy. First driver 145 may be described as a haptic driver for ERM, LRAs or piezoelectric actuators with a built in library and smart-loop architecture. For example, driver 145 may be similar to the DRV2605 line of haptic drivers the sold by Texas Instruments®, such as the Texas Instruments DRV2605L, which provides flexible control of first haptic generator 131 over a shared I²C-compatible bus and is further described at https://www.digikey.com/en/product-highlight/t/texas-instruments/drv2605-haptic-driver (accessed Oct. 16, 2023), the entirety of which is hereby incorporated by reference into this disclosure.

Second haptic driver 146 may be operable to generate the above-described second control signal for causing cold outputs of the thermal energy and third control signal for causing heat outputs of the thermal energy. Second driver 146 may be described as a haptic driver for thermoelectric pellets 135. For example, driver 146 may be similar to a Thermoelectric Cooler PMIC 24-LFCSP (4×4) described and sold by Analog Devices Inc. with reference to Analog Devices ADN883ACPZ at https://www.digikey.com/en/products/detail/analog-devices-inc/ADN8834ACPZ-R7/5726006 (accessed Oct. 16, 2023), the entirety of which is hereby incorporated by reference into this disclosure.

Power controller 143 and USB driver 144 may be selected for use with microcontroller 142, first haptic driver 145, and second haptic driver 146.

Sensor 147 may comprise one or more temperature sensors that communicate with the microcontroller 142 to regulate the thermal outputs from the second haptic generator 133, such as the cold and hot outputs generated with the above-described first and second groups of thermoelectric pellets 135. As shown in FIG. 6, sensor 147 may comprise a pins temperature sensors that are strategically placed inside of housing 110 to measure different operational aspects of multi-energy haptic generator 100. For example, sensor 147 may comprise a first temperature sensor engaged with an outward-facing side of base PCB 141 to measure waste heat, a second temperature sensor engaged between PCBs 134, 136 in lieu of one of pellets 135 to monitor a temperature approximate to skin 2 (e.g., as shown in FIG. 6), and/or a third temperature sensor 147 engaged with a skin-facing side of interface PCB 136 to monitor a temperature at skin 2. In keeping with above, each sensor 147 may output sensory data to microcontroller 142 for use in generating the above-referenced first, second, and/or third control signals.

As shown in FIG. 6, port 148 may comprise a USB-C port and USB driver 144 may be compatible therewith. Although shown as being wired, port 148 may comprise any wired and/or wireless technologies for transmitting data and/or power second circuit assembly 140 responsive to any local or remote data source, including sensor 147.

As shown in FIG. 5, first circuit assembly 130 may be removably engaged with second circuit assembly 140 via pins 160 to create in a linear stack of PCBs that (i) electrically and mechanically connect first haptic generator 131 (e.g., an LRA) and second haptic generator 133 (e.g., thermoelectric pellets 135) to the driving components of second circuit assembly 140; and (ii) coaxially arrange the generating elements of generators 131, 133 so that their respective energies are output in approximately the same direction toward skin 2. As shown in FIGS. 4-6, the use of multiple PCBs in a linear stack may facilitate and streamline the interface of different types of single-energy haptic generators within multi-energy haptic generator 100 by accounting for varying thicknesses of their respective generating elements and enabling seamless electrical and mechanical connections to the driving components on base PCB 141. As shown in FIG. 5, thermoelectric pellets 135 may be soldered between at least two PCBs (i.e., PCBs 134, 136), although any number of additional stacks of pellets 135 may be electrically connected via pins 160 in a similar manner for enhanced heat transfer and/or efficiency.

First circuit assembly 130 may be constructed by engaging the outward- and skin-facing surfaces of thermoelectric pellets 135 with their respective pads 173 and/or 174 on the interior surfaces of interconnecting PCB 134 and interface PCB 136 to create a TEC sub-assembly. To prevent thermal energy transfer between the outward- and skin-facing surfaces of thermoelectric pellets 135, an insulative material (e.g., such as an epoxy having an R-value of 7 to 9) may be injected into the void(s) between and/or surrounding pellets 135 after being incorporated into the TEC sub-assembly. The insulating material may help to ensure that pellets 135 are able to deliver effective heating and cooling in targeted areas. As shown in FIG. 5, each pin 160 may be rigidly engaged with a portion of the TEC sub-assembly, such as a with an opening of PCB 134.

Adapter 132 and first circuit assembly 130 may comprise conductive openings sized to receive pins 160, allowing electricity to flow therebetween while allow making it possible to swap them out and/or adjust distances between. Adapter 132 may be fixedly engaged to first haptic generator 131 (e.g., soldered), slidably engaged with pins 160, and slid into position against interconnecting PCB 134. As shown in FIG. 5, base PCB 141 may be slidably engaged with pins 160 and slid into position against adapter 132. The aforementioned insulating material may be used to partially or fully encapsulate first haptic generator 131 (e.g., the LRA), securing it in place and optimizing vibrations transmitted in directions toward skin 2. The insulating material (e.g., the epoxy) also may mechanically isolate the first haptic generator 131 from other energy sources or control electronics.

Pins 160 may be particularly helpful when configuring aspects of first circuit assembly 130 or second circuit assembly 140, such as by making them more easily interchangeable and allowing for different configurations of haptic motors or thermoelectric setups and different engagement elements for use with different garments or sleeves. Pins 160 also may be used to provide a secure connection between assemblies 130, 140, such as when assemblies 130, 140 are soldered to pins 160 after being configured.

Pins 160 may be conductive although that is not required. For example, pins 160 may be formed of an electrically non-conductive material (e.g., a thermoplastic) and similarly used to connect assemblies 130 and 140. In this example, electrically non-conductive material may be employed for mechanical connections to vibrationally isolate first haptic generator 131 from second haptic generator 133 and the driving components on base PCB 141. The electrically non-conductive material may be thermally conductive (e.g., a thermally conductive thermoplastic), allowing it to provide the vibrational isolation while also providing a thermally conductive pathway for dissipating waste heat. In these examples, the conductive aspects of pins 160 may be supplemented with and/or replaced with flexible cables for electrical connections.

As shown in FIG. 8 and described herein, second haptic generator 133 may utilize the Peltier effect to generate outputs of thermal energy by employing N-type and P-type semiconductors (e.g., labelled as 135-N and 135-P) to create a heat flux in the HFD. By independently controlling the intensity and direction of the electric current flowing through the different electrically conductive vias of PCBs 134, 136, different groups of pellets 135 may cool down or heat up independently, allowing for targeted temperature control schemes to be deployed for second haptic generator 133.

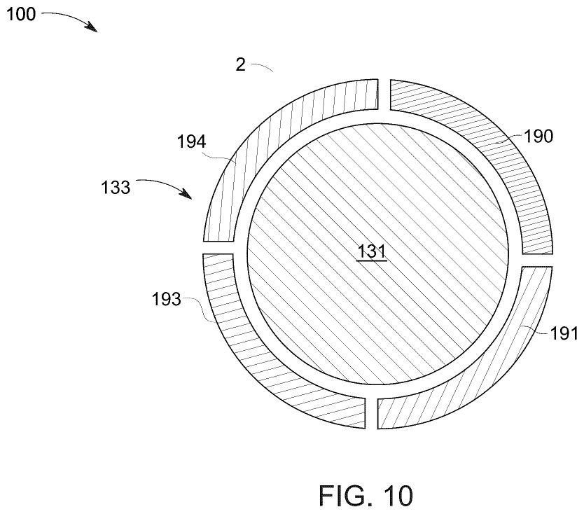

Independent control of groups of thermoelectric pellets 135 may be utilized to create thermal effects such as waves or cycles that go beyond just on-off control. As shown in FIG. 10, a segmented control scheme may be deployed for second haptic generator 133, in which groups of pellets 135 in quadrants 190, 191, 192, and 193 about the radial array (e.g., each including one pair 171 and one pair 172) may be activated at different times to generate concentrated and/or partial outputs of thermal energy. For example, in a communication application, if multi-energy generator 100 of FIG. 10 is correctly oriented on a forearm of user 1, then a first output from upper-right quadrant 191 may be used in concert with vibration to communication a need for user 1 to move right and a second output from upper-left quadrant 190 may be used with vibration to communicate a need for user 1 to move left, and so on relative each quadrant 190, 191, 192, and 193. As a further example, in a therapeutic application, movements of thermal energies around quadrants 190, 191, 192, and 193 may be used to affect underlying tissues, such as by promoting blood flows to and within certain areas of the body.

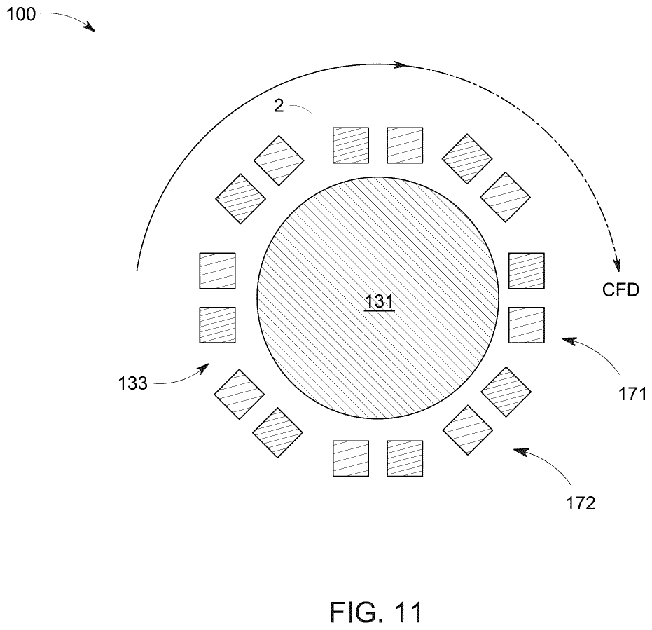

As shown in FIG. 11, an individual control scheme also may be deployed for second haptic generator 133, in which different groups of pellets 135 (e.g., one pair 171, 172, etc.) are individually activated in sequence around the radial array (e.g., pair 171 then pair 172) to generate circular outputs of the thermal energy. As shown in FIG. 11, the resulting current flow direction or CFD may cause a rotation of thermal outputs that are directed toward skin 2 in sequence to create a circular, swirling effect, in which the cold or hot outputs may be perceived by the brain of user 1 as moving around the radial array. The CFD may be clockwise (e.g., as shown in FIG. 11) or counterclockwise. The hold and cold outputs may include different types of temperature swings, such as from a normal temperature of skin 2 to maximum cold or hot and/or from maximum cold to maximum hot and vice versa, depending upon the desired effect.

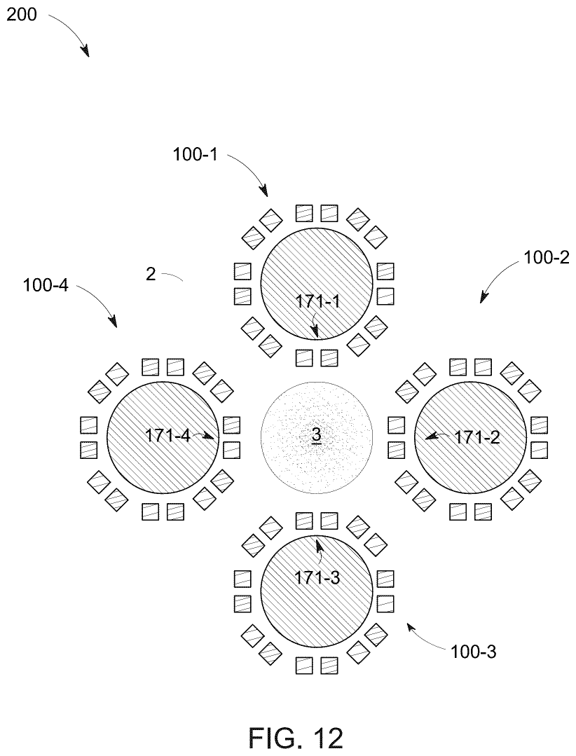

Similar control schemes may be deployed when a pins multi-energy haptic generators 100 are assembled into an array on skin 2. As shown in FIG. 12, an exemplary multi-energy haptic system 200 may comprise a plurality of multi-energy haptic generators 100 as described herein, including a first multi-energy haptic generator 100-1, a second multi-energy haptic generator 100-2, a third multi-energy haptic generator 100-3, and a fourth multi-energy haptic generator 100-4 oriented in a diamond shape on skin 2. A segmented control scheme may be deployed for second haptic generators 133 of FIG. 12 by activating adjacent pairs of thermoelectric pellets 135 to create concentrated thermal outputs in a central area 3 of skin 2 located therebetween. As shown in FIG. 12, each of generators 100-1, 100-2, 100-3, and 100-4 may comprise a pair 171 of thermoelectric elements (e.g., as in FIG. 8) that are adjacent central area 3 and correspondingly labeled as pairs 171-1, 171-2, 171-3, and 171-4. In this example, microcontroller 142 (e.g., associated with one or more of generators 100-1, 100-2, 100-3, and 100-4) may cause pairs 171-1, 171-2, 171-3, and 171-4 to output a maximum cold or hot output that is perceived by skin 2 throughout central area 3.

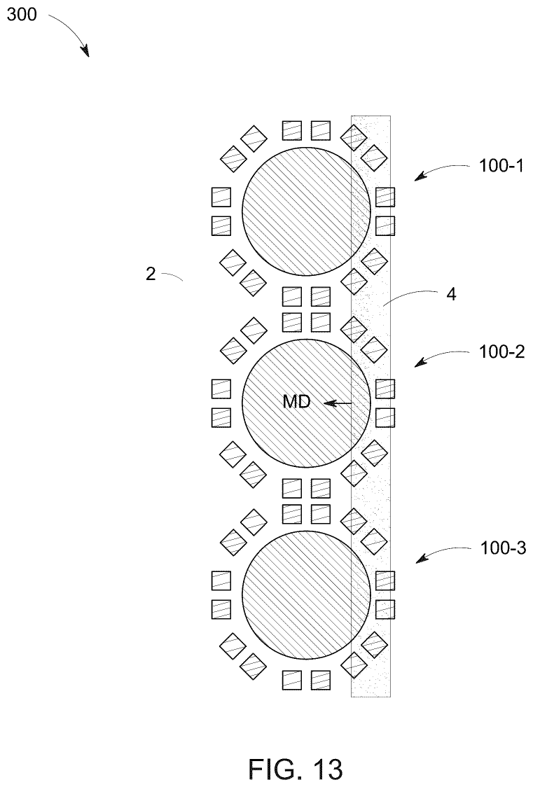

Similar effects maybe realized with any arrangement of generators 100. As shown in FIG. 13, an exemplary multi-energy haptic system 300 may comprise a plurality of multi-energy haptic generators 100 as described herein, including first multi-energy haptic generator 100-1, second multi-energy haptic generator 100-2, and third multi-energy haptic generator 100-3 oriented in a linear shape on skin 2. In keeping with above, the individual control scheme may be similarly deployed by generators 100-1, 100-2, and 100-3 to create a thermal wave effect 4 shown as a rectangle of thermal energy as moving across the linear array of system 300 in a movement direction or MD from right to left.

Aspects of multi-energy haptic generator 100 may be modified to enhance an intensity and/or perceptibility of different haptic energy types. As shown in FIG. 9, the PCB of adapter 132 may comprise a central mounting portion 180 and a beam structure 181 operable to help focus the vibratory energy. An outward-facing surface of haptic generator 131 may be fixedly engaged with central mounting portion 180 and a skin-facing surface of generator 131 may be fixedly engaged with indenter 120. Second circuit assembly 140 may be engaged with an outward-facing surface of central mounting portion 180 and second haptic generator 133 may be engaged with adapter 132 (e.g., via pins 160). In this configuration, the material composition and curvature of beam structure 181 may help to resiliently press first haptic generator 131 toward skin 2 when multi-energy haptic generator 100 is worn adjacent skin 2. Indenter 120 may be similarly operable to help focus the vibratory energy. By way of example, as shown in FIG. 9, indenter 120 may comprise may be made of an elastomer (e.g., silicone, nitrile) operable to output the vibratory energy over many cycles without deformation due to strain. Indenter 120 may be made with different materials and/or combinations of materials to vary perceived vibrations by user 1's brain via skin 2. Although shown as having a semi-spherical shape, indenter 120 may also comprise varying topology including any structures operable to modify the vibrational energy detectable by user 1's brain by focusing it on different areas of skin 2.

Other aspects of multi-energy haptic generator 100 may be modified to help focus the thermal energy. As shown in FIG. 6, the electrically conductive vias in a thermally insulating substrate of interface PCB 136 may direct thermal energies from second generator element 133 toward skin 2 through skin interface 112, either conductively through or with elements physically extending through interface 112. As shown in FIGS. 1-2, the skin-facing surface of interface PCB 136 may comprise conductive pads operable with second skin contact 119 of skin interface 112 to create hot/cold spots for intensifying the thermal energies. For example, the conductive pads may be adjacent to, embedded in, or sized to extend through skin contact 119. The size and shape of indenter 120 and/or the conductive pads may vary. In this example, a smaller indenter 120 and/or conductive pad may allow for pinpoint heating and cooling whereas as a larger indenter 120 and/or pad may promote even thermal energy distribution.

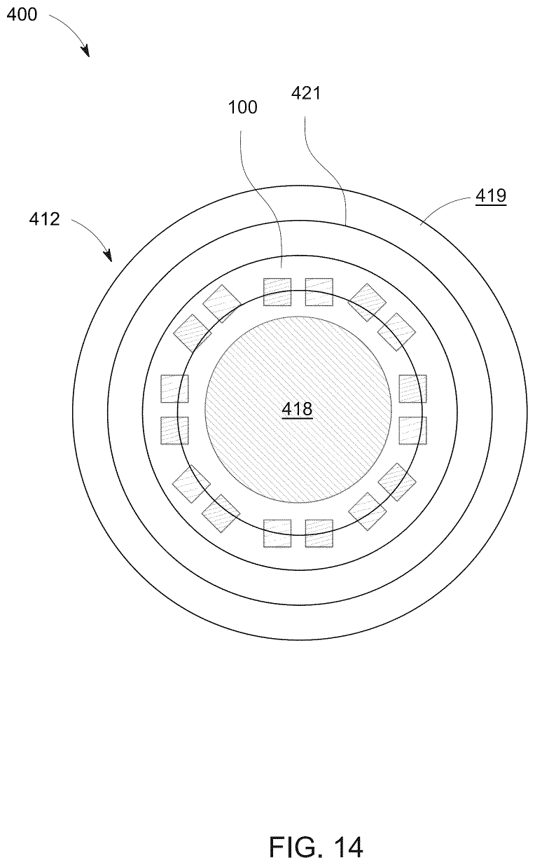

Still other aspects of multi-energy haptic generator 100 may be modified to help spread the thermal energy over areas of skin 2 that extend beyond housing 110. As shown in FIG. 6, second skin contact 119 also may comprise and/or be thermally coupled to a heat spreading element positioned to receive and spread thermal energies output from skin-facing surfaces of thermoelectric pellets 135. The heat spreading element may be rigid, flexible, stretchable, or in paste form, possessing high thermal conductivity to facilitate heat transport to areas extending beyond an outer diameter of housing 110. As shown in FIG. 14, which shows an outward-facing view of skin interface 112 looking directly at its skin-facing surface, an exemplary multi-energy haptic system 300 according to this disclosure may comprise a multi-energy haptic generator 100 as described herein, but with a skin interface 412 comprising a first skin contact portion 418 like that of skin contact 118 described herein and a second skin contact 419 that extends beyond an outer perimeter of generator 400.

As shown in FIG. 14, skin interface 412 may comprise a circular disc made from a thermally conductive silicon. One or more conductive rings 421 may be embedded the disc to help evenly distribute the thermal energies. Other conductive elements may be used. For example, as above, one or both of first skin contact 418 and second skin contact 419 may be formed from a lightweight liquid metal embedded elastomer composition like those described in U.S. Provisional Patent No. 63/153,480, filed Feb. 25, 2021, the entirety of which is hereby incorporated by references into this disclosure. For portion 418, the amount of embedded metal may be utilized to amplify the vibratory energy by increasing its mass; and for portion 419, the amount of embedded metal may increase its thermal conductivity.

As shown in FIG. 14, an outward-facing side of skin interface 412 may be rigidly engaged with housing 110 and a skin-facing side of interface 412 may comprise a biocompatible adhesive so that multi-energy haptic generator 100 may be worn directly on skin 2 by placing interface 412 (or interface 112) against skin 2 until the biocompatible adhesives forms a bond sufficient to support a weight of generator 100. Other types of adhesive may be used. For example, a sheet of biocompatible tape may be placed over generator, adhered to adjacent portions of skin, and operable to press interface 412 into skin 2.

While principles of the present disclosure are disclosed herein with reference to illustrative aspects for particular applications, the disclosure is not limited thereto. Those having ordinary skill in the art and access to the teachings provided herein will recognize additional modifications, applications, aspects, and substitution of equivalents all fall in the scope of the aspects disclosed herein. Accordingly, the present disclosure should not be considered as limited by the foregoing description.

1. A multi-energy haptic generator apparatus comprising:
a housing with a biocompatible skin interface comprising:
a first skin contact operable to transmit a first haptic energy in a signal direction toward skin of a user; and
a second skin contact that surrounds the first skin contacting portion and is operable to transmit a second haptic energy in the signal direction toward the skin; and
a plurality of PCBs that are operatively sealed in the housing, the plurality of PCBs comprising:
a first haptic generator operable to output the first haptic energy to the first skin contact for transmission to the skin;
a second haptic generator that surrounds the first haptic generator and is operable to output the second haptic energy to the second skin contact for transmission to the skin; and
a haptic controller operable to activate the first haptic generator and the second haptic generator.

2. The apparatus of claim 1, wherein:
the housing comprises an aluminum portion that mechanically supports and is thermally coupled to the plurality of PCBs; and
the aluminum portion is operable as a heat sink for one or more of the first haptic generator, the second haptic generator, and the haptic controller.

3. The apparatus of claim 1, wherein:
the housing comprises a front cover with an opening;
the plurality of PCBs are operatively sealed in the housing by a seal formed between the biocompatible skin interface and the opening;
the second skin contact comprises an annular shape with a central opening;
the first skin contact is receivable in the central opening; and
the plurality of PCBs are operatively sealed in the housing by an outer seal formed between the second skin contact and the opening an inner seal formed between the first skin contact and the second skin contact.

4. The apparatus of claim 3, wherein:
the first skin contact comprises an indenter that is engaged with the first haptic generator and operable to focus the first haptic energy on a smaller area of the skin when the apparatus is pressed against the skin; and
the indenter comprises a semi-spherical shape that is engaged with the first haptic generator and made of first biocompatible material operable to transmit the first haptic energy to the smaller area of the skin,
comprising an adapter that attaches the first haptic generator to the plurality of PCBs and resiliently presses the indenter toward the smaller area of the skin when the apparatus is pressed against the skin.

5. The apparatus of claim 1, wherein:
the first haptic energy consists essentially of a vibratory energy and the first skin contact comprises a first biocompatible material operable to transfer the vibratory energy to the skin; and
the first biocompatible material comprises a heat-resistant silicone.

6. The apparatus of claim 5, wherein the first biocompatible material contains an embedded amount of liquid metal that increases a mass the first skin contact.

7. The apparatus of claim 6, wherein:
the second haptic energy consists essentially of a thermal energy;
the second skin contact comprises a second biocompatible material operable to transfer the thermal energy to the skin; and
the second biocompatible material comprises a thermally conductive silicone.

8. The apparatus of claim 7, wherein the second biocompatible material comprises an embedded amount of liquid metal positioned to increases a thermal conductivity of the second skin contact.

9. The apparatus of claim 1, comprising an insulative element that is contained in the housing and positioned to maintain a position of the plurality of PCBs in the housing and limit flows of electricity and heat between the plurality of PCBs, wherein the insulative element comprises a dielectric epoxy contained in voids between the first haptic generator and the second haptic generator.

10. The apparatus of claim 1, wherein the plurality of PCBs comprise:
a vertically integrated circuit stack that is engaged with and operatively sealed in the housing; and
pins operable to form the vertically integrated circuit stack by mechanically attaching the plurality of PCBs to one another,
each pin comprising:
a conductive material operable to transmit electricity between the plurality of PCBs; and
a thermally conductive portion operable to transmit thermal energy between the plurality of PCBs and an electrically insulative portion operable to limit transmissions of electricity between the plurality of PCBs.

11. The apparatus of claim 1, wherein:
the first haptic energy consists essentially of a vibratory energy;
the first haptic generator is operable to output the vibratory energy responsive to a first electric current directed to the first haptic generator; and
the first haptic generator comprises a linear resonate actuator or a piezoelectric actuator operable to output the vibratory energy responsive to the first electric current.

12. The apparatus of claim 11, wherein:
the second haptic energy consists essentially of a thermal energy;
the second haptic generator is operable to output the thermal energy responsive to a second electric current directed to the second haptic generator;
the second haptic generator comprises a thermoelectric element operable via the Peltier effect to output the thermal energy responsive to the second electric current;
the thermal energy comprises a cold energy and a heat energy; and
the thermoelectric element is reversibly operable to output the cold energy or the heat energy based on a direction of the second electric current.

13. The apparatus of claim 12, wherein the thermoelectric element comprises:
an interconnecting PCB attachable to the first haptic generator;
an interface PCB attachable to the second skin contact; and
thermoelectric pellets contained between the interconnecting PCB and the interface PCB.

14. The apparatus of claim 13, wherein:
the interconnecting PCB and the interface PCB define electrically conductive vias extending between the thermoelectric pellets;
the thermoelectric pellets are operable with the electrically conductive vias to convert the second electric current into the thermal energy;
the interconnecting PCB and the interface PCB comprise annular shapes;
the thermoelectric pellets are arranged between the annular shapes in a radial array; and
the first haptic generator is located in a central opening of the annular shapes.

15. The apparatus of claim 13, wherein:
the thermoelectric pellets comprise two different types of semiconductors that are engaged in pairs;
the two different types of semiconductors in each pair comprise one N-type thermoelectric semiconductor and one P-type thermoelectric semiconductor;
the N-type and P-type thermoelectric semiconductors are made of Bi₂Ti₃;
a polarity of each N-type thermoelectric semiconductor is different from a polarity of each N-type thermoelectric semiconductor.

16. The apparatus of claim 13, wherein:
the interconnecting PCB comprises a first substrate and the interface PCB comprises a second substrate;
the first substrate and the second substrate are made of different materials with different conductivities;
the first substrate comprises a thermally insulating material; and
the second substrate comprises a thermally conductive material.

17. The apparatus of claim 16, wherein:
the first substrate comprises ceramic, FR4, or polycarbonate; and
the second substrate comprises aluminum or gallium nitride.

18. The apparatus of claim 1, wherein:
the plurality of PCBs comprise a base PCB for the haptic controller comprising a microcontroller, a power controller, a USB driver, a first haptic driver for the first haptic generator, a second haptic driver for the second haptic generator, and a sensor; and
the microcontroller is operable to send:
first control signals for routing the first electric current the first haptic generator in a first direction causing outputs of the cold energy;
second control signals for routing the second electric current to the second haptic generator in a direction causing outputs of the heat energy;
third control signals for routing the second electric current to the second haptic generator in an opposite direction causing outputs of the vibratory energy; and
fourth control signals for causing the sensor to generate or output sensory data.

19. The apparatus of claim 18, wherein:
the sensor comprises one or more temperature sensors that communication with the microcontroller to regulate the thermal energy; and
the one or more temperature sensors comprise:
a first sensor on the base PCB;
a second sensor engaged between the interconnecting PCB and the interface PCB; and
a third sensor engaged with a skin-facing side of the interface PCB.

20. The apparatus of claim 1, comprising a spreader that is removably engageable with the second skin contact and operable to spread the second haptic energy over a larger area of the skin, wherein the spreader comprises:
a biocompatible base material;
conductive elements that are embedded in the base material to increase is thermal conductivity; and
a biocompatible adhesive operable to attach the apparatus to the skin.
